(19) United States
(12) Patent Application Publication
(10) Pub. No.: US 2025/0310314 A1
(43) Pub. Date: Oct. 2, 2025

(54) METHOD FOR PROCESSING RELIABILITY OF SITE WITHIN INTRANET ON VIRTUAL MACHINE OUTSIDE INTRANET

(71) Applicant: CANON KABUSHIKI KAISHA, Tokyo (JP)

(72) Inventor: SHINGO IWASAKI, Kanagawa (JP)

(21) Appl. No.: 19/079,100

(22) Filed: Mar. 13, 2025

(30) Foreign Application Priority Data
Mar. 28, 2024 (JP) 2024-054572

(51) Int. Cl. H04L 9/40

(52) U.S. Cl. CPC H04L 63/0823; H04L 63/1416; H04L 63/20

(57) ABSTRACT

An information processing apparatus that provides a rendering result of a web page based on a request from a communication terminal connected to an intranet includes receiving a root certificate for a website on the intranet from the communication terminal and a performing, when the web page of the website on the intranet is rendered, verification of reliability of the website on the intranet with the root certificate.

### BACKGROUND

### Field

The present disclosure relates to a processing system and an information processing method for processing reliability of a site within an intranet on a virtual machine external to the intranet.

### Description of the Related Art

There have been widespread communication terminals equipped with web browsers (hereinafter, referred to as browsers) for users to browse web pages including HyperText Markup Language (HTML) documents on. By displaying web pages of external services that operates on external servers using the browsers, the communication terminals can cooperate with the external services.

Meanwhile, as a type of browsers, there is a cloud browser that generates rendering results of web pages on a cloud server. Execution of processing with high calculation load, such as analysis processing and execution processing of a web page, on the server reduces the calculation load of communication terminals.

Regarding cloud browsers, browser engines that perform processing of analyzing web pages and generating rendering results are implemented on virtual machines operating on cloud servers. Browser engines implemented on cloud servers render web pages, convert the rendering results into images, and provide image data as the rendering results to communication terminals, and the communication terminals display the image data. In this way, users browse web pages. Further, when input information (input events performed on keyboards, mouses, or touch panels) entered on communication terminals is transmitted to cloud servers and passed on to browser engines that operate on the cloud server, that allows browsers to be operated and to look as if the browsers operated on the communication terminals. Various kinds of device resources used for personal computers (PCs) are virtually allocated to virtual machines. Thus, a browser engine or browser engines running on a virtual machine can be operated in the same manner as on a PC.

Pieces of processing performed by browsers include processing of connecting to sites on an intranet, rendering web pages of the sites, and providing the rendered image data to communication terminals. Some sites on an intranet issue dedicated server certificates and dedicated root certificates to enhance the security by encrypted communication based on HTTPS connection.

There is a disclosed method in which dedicated root certificates are additionally registered in a shared region in an image forming apparatus, such as a multifunction peripheral (MFP), to establish connections from applications in the image forming apparatus to sites on an intranet that issue the dedicated server certificates and dedicated root certificates (Japanese Patent Application Laid-Open No. 2019-49799).

With the above-described technique implemented, when an application of an image forming apparatus, such as a browser, connects to a site on an intranet that issues a dedicated server certificate and a dedicated root certificate, the image forming apparatus can verify the reliability of the site on the intranet.

However, the above-described technique does not verify the reliability of the site on the intranet with a cloud browser on a virtual machine outside the intranet.

### SUMMARY

In view of the above issue, the present disclosure is directed to enabling verification of the reliability of a site within an intranet using a cloud browser on a virtual machine external to the intranet.

According to an aspect of the present disclosure, an information processing apparatus that provides a rendering result of a web page based on a request from a communication terminal connected to an intranet includes an interface device configured to receive a root certificate for a website on the intranet from the communication terminal, and a memory storing a program and a processor configured to, when executing the program, cause the information processing apparatus to perform, when the web page of the website on the intranet is rendered, verification of reliability of the website on the intranet with the root certificate.

Further features of the present disclosure will become apparent from the following description of exemplary embodiments with reference to the attached drawings.

### BRIEF DESCRIPTION OF THE DRAWINGS

FIG. 1 is an example of a block diagram illustrating the configuration of an information processing system.

FIG. 2 is an example of a block diagram illustrating the hardware configuration of a communication terminal.

FIG. 3 is an example of a block diagram illustrating the hardware configuration of a virtual machine.

FIG. 4 is an example of a flowchart illustrating a process of the communication terminal.

FIG. 5 is an example of a flowchart illustrating a process of an image generation system.

FIG. 6 is an example of a flowchart illustrating a process of the communication terminal.

FIG. 7 is an example of a flowchart illustrating a process of the image generation system.

### DESCRIPTION OF THE EMBODIMENTS

Some exemplary embodiments of the present disclosure will now be described with reference to the drawings. The following exemplary embodiments are not seen to limit the present disclosure. Not all of the combinations of features described in the exemplary embodiments need to be used by the present disclosure. The same components will be denoted by the same reference numerals.

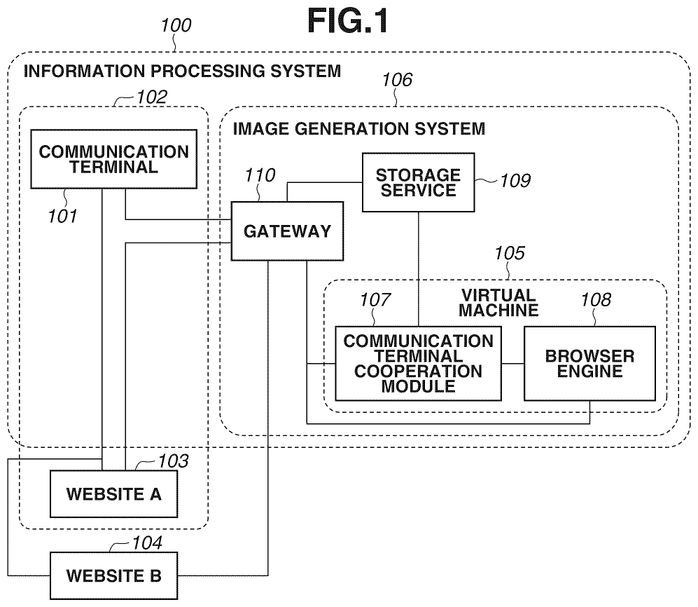

A first exemplary embodiment will now be described. FIG. 1 is an example of a block diagram illustrating the configuration of a system according to the present exemplary embodiment.

An information processing system 100 includes a communication terminal 101 and an image generation system 106.

A user browses and operates a screen of the communication terminal 101. The communication terminal 101 is connected to the image generation system 106 via a network, and transmits operation information and image acquisition requests of rendering results to the image generation system 106. The network in the present exemplary embodiment can be any combination of the Internet, a wide area network (WAN), and a local area network (LAN). A plurality of communication terminals can be provided.

An intranet 102 includes the communication terminal 101 connected thereto and a website A 103 accessible within the intranet 102. The website A 103 holds a web page specified by a Uniform Resource Locator (URL) and files linked to the web page.

A website B 104 is a general external service, such as a search site or a news site on the Internet external to the intranet. Like the website A 103, the website B 104 holds a web page specified by a URL and files linked to the web page. The image generation system 106 includes a virtual machine 105, a storage service 109, and a gateway 110. The image generation system 106 may be any information processing apparatus as long as the information processing apparatus accesses a web page specified by a URL and acquires a rendering result of the web page. For example, the image generation system 106 has at least the functions of the virtual machine 105, the storage service 109, and the gateway 110, and can be configured to include each of the above components as a separate body. The virtual machine 105 includes a communication terminal cooperation module 107 and a browser engine 108.

A basic process of a cloud browser until a web page is displayed on the communication terminal 101 will now be described.

When the user enters a URL on the communication terminal 101, the URL is sent to the communication terminal cooperation module 107 of the image generation system 106. The communication terminal cooperation module 107 requests the browser engine 108 to acquire and analyze the web page specified by the URL, and to generate an image from the rendering result. The browser engine 108 accesses the website A 103 or the website B 104 via the gateway 110, acquires and analyzes the web page specified by the URL, and generates the image from the rendering result. The browser engine 108 notifies the communication terminal cooperation module 107 of completion of generation of the rendering result image. Upon receiving the notification of the completion of the generation of the rendering result image from the browser engine 108, the communication terminal cooperation module 107 acquires the rendering result image from the browser engine 108 and stores the image in the storage service 109 connected via the network.

The communication terminal cooperation module 107 notifies the communication terminal 101 of completion of storage of the rendering result image. Upon receiving the notification of the completion of the storage of the rendering result image from the communication terminal cooperation module 107, the communication terminal 101 requests the storage service 109 to acquire and display the rendering result image.

A process performed when the security of the website A 103 and the website B 104 is enhanced by encrypted communication based on HTTPS connection will now be described.

The website B 104 is a general external service, such as a search site or a news site, on the Internet external to the intranet. Thus, when the web browser of a PC accesses the website B 104, the server certificate for the website B 104 is verified with the root certificate to verify the reliability of the website B 104. The root certificate used in this case is generally available to the public, and is provided in advance in the operating system (OS) or the web browser on the PC. In the cloud browser, the OS of the virtual machine 105 or the browser engine 108 holds the root certificate for the website B 104. Thus, the cloud browser can verify the reliability of the website B 104 and access the website B 104.

The website A 103 is made accessible within the intranet, and its security is enhanced by encrypted communication based on HTTPS connection with the issued dedicated server certificate and root certificate. The dedicated root certificate for the website A 103 is additionally registered to PCs within an intranet, for example. Thus, the PCs can verify the reliability of the website A 103 and access the website A 103.

In the cloud browser, the virtual machine 105 external to the intranet is used to verify the reliability of the website A 103. However, when the virtual machine 105 does not hold the dedicated root certificate for the website A 103 on the intranet, the virtual machine 105 cannot verify or access the website A 103.

In the present exemplary embodiment, a process for verifying the reliability of the website A 103 used when the cloud browser accesses the website A 103 on the intranet with enhanced security by encrypted communication based on HTTPS connection will be described.

The intranet 102 monitors access from external to the intranet with an installed proxy in some cases. While there are various kinds of methods for accessing the intranet from external to the intranet, such as communication tunneling, the detailed description of the methods for accessing the intranet from external to the intranet will be omitted in the present exemplary embodiment. The present exemplary embodiment is described based on the assumption that the image generation system 106 can access the communication terminal 101 and the website A 103 via the gateway 110.

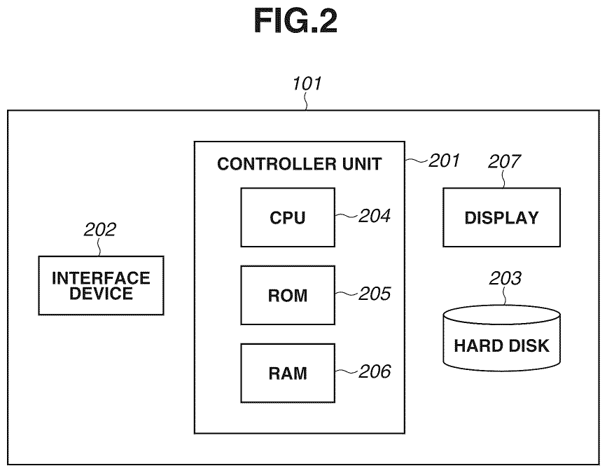

FIG. 2 is a block diagram illustrating an example of a hardware configuration of the communication terminal 101 according to the present exemplary embodiment. The communication terminal 101 includes, as main components, a controller unit 201 that generally controls the apparatus, an interface device 202, a hard disk 203, and a touch panel display 207. The controller unit 201 includes a central processing unit (CPU) 204, a read-only memory (ROM) 205, and a random access memory (RAM) 206.

The interface device 202 connects the communication terminal 101 to a network. The communication terminal 101 can be connected to the image generation system 106, the website A 103, and the website B 104, and can perform data transmission and reception via the interface device 202.

The CPU 204 executes the processing of various processing units in the communication terminal 101. The ROM 205 stores various kinds of programs to be executed by the CPU 204 and data for the programs. Some programs and data are stored in advance in the hard disk 203 as an external storage device, and read to the RAM 206 to be executed. In the present exemplary embodiment, programs for controlling the function of sending the root certificate for a site on the intranet are stored in the ROM 205 or the hard disk 203, and the CPU 204 executes the processing of the programs. The RAM 206 is a work area for the processing units in the communication terminal 101, and temporarily stores data to be used during the execution of the programs.

The touch panel display 207 is a device that serves as both a display unit and an operation unit in the present exemplary embodiment. The touch panel display 207 displays various kinds of image information on a display area and receives input of touch operations by the user. In the present exemplary embodiment, the touch panel display 207 displays the execution screen of a viewer, which is an application for acquiring and displaying the image of the rendering result of a web page. User interface (UI) operation items, such as buttons that respond to input operations by the user and a software keyboard used for entering characters, are displayed as a graphical user interface (GUI). The touch panel display 207 includes touch sensors provided in the display area. When the user touches the touch panel display 207 with a finger, for example, signals detected by a touch sensor are processed with a touch-sensor program stored in the ROM 205, and the touched positions are calculated as coordinates on the touch panel display 207. A program for displaying the GUI acquires the touched UI operation items and details of the operation based on the calculated coordinates and the coordinates of the UI operation items constituting the GUI displayed on the touch panel display 207.

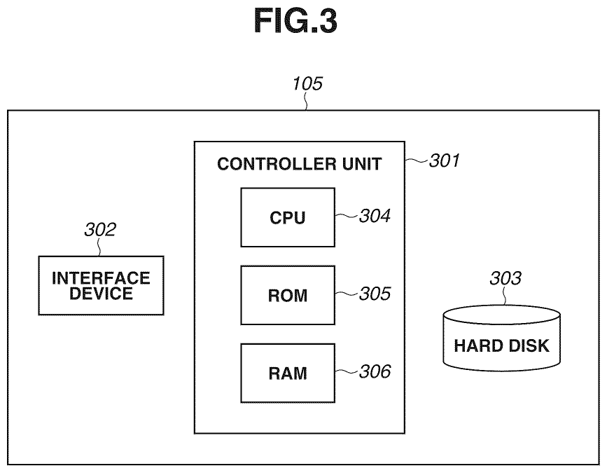

FIG. 3 is a block diagram illustrating an example of a hardware configuration of the virtual machine 105 according to the present exemplary embodiment. The virtual machine 105 includes, as main components, a controller unit 301 that controls the virtual machine 105, an interface device 302, and a hard disk 303. The controller unit 301 includes a CPU 304, a ROM 305, and a RAM 306.

The CPU 304 executes the processing of various processing units in the virtual machine 105. The ROM 305 stores various kinds of programs to be executed by the CPU 304 and data for the programs. Some programs and date are stored in advance in the hard disk 303 as an external storage device, and read to the RAM 306 to be executed. In the present exemplary embodiment, programs for controlling, for example, the verification of the reliability of the website A 103 with the root certificate sent from the communication terminal 101 is stored in the ROM 305 or the hard disk 303, and the CPU 304 executes the processing of the programs. The RAM 306 is a work area for the processing units in the virtual machine 105, and temporarily stores data to be used during the execution of the programs.

The interface device 302 connects the virtual machine 105 to a network. The virtual machine 105 can be connected to the communication terminal 101, the website A 103, the website B 104, and the storage service 109, and can perform data transmission and reception via the interface device 302.

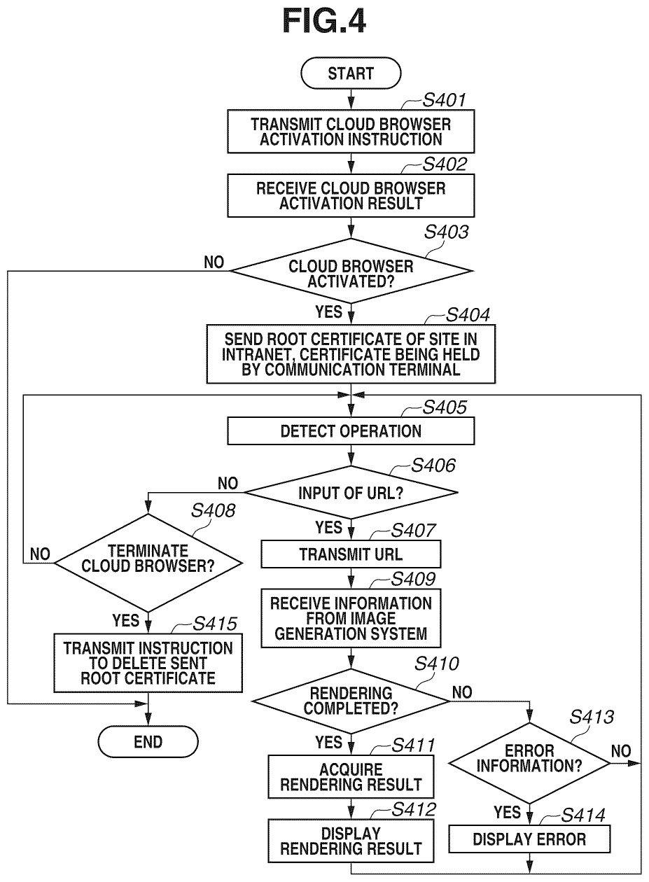

A procedure of the general process according to the present exemplary embodiment executed by the communication terminal 101 will be described with reference to the flowchart illustrated in FIG. 4. The process of the flowchart illustrated in FIG. 4 is performed when the CPU 204 stores programs, which are stored in the ROM 205, in the RAM 206, and executes the programs.

In step S401, the communication terminal 101 transmits an activation instruction for a cloud browser to the image generation system 106.

In step S402, the communication terminal 101 receives an activation result of the cloud browser from the image generation system 106.

In step S403, based on the result received in step S402, the communication terminal 101 determines whether the cloud browser is activated. If the cloud browser is activated (YES in step S403), the processing proceeds to step S404. If the cloud browser is not activated (NO in step S403), the processing ends.

In step S404, the communication terminal 101 sends a root certificate for a site on the intranet to the cloud browser activated in the image generation system 106, i.e., to the virtual machine 105. For example, the communication terminal 101 stores the root certificate in its shared area. When holding a plurality of root certificates, the communication terminal 101 sends all of the root certificates.

In step S405, the communication terminal 101 detects a user operation performed on its screen.

In step S406, the communication terminal 101 determines whether the operation detected in step S405 is an input of a URL for accessing a website. In the present exemplary embodiment, suppose that a URL for accessing the website A 103 is entered in step S405. If the operation in step S405 is an input of a URL (YES in step S406), the processing proceeds to step S407. If the operation is not an input of a URL (NO in step S406), the processing proceeds to step S408. The present exemplary embodiment does not limit the methods for entering a URL. The user may directly enter a URL using a software keyboard displayed on the screen, or may specify a URL with a function corresponding to a bookmark used in a general web browser.

In step S407, the communication terminal 101 transmits the URL entered thereon by the user to the image generation system 106.

In step S409, the communication terminal 101 receives information sent from the image generation system 106. Examples of the information include a state indicating that the rendering is completed, a URL for accessing the rendering result stored in the storage service 109 of the image generation system 106, and error information indicating that the rendering is not generated.

In step S410, the communication terminal 101 determines whether the information received in step S409 includes information indicating that the rendering for the URL transmitted to the image generation system 106 in step S407 is completed. If the information is included (YES in step S410), the processing proceeds to step S411. If the information is not included (NO in step S410), the processing proceeds to step S413.

In step S411, the communication terminal 101 accesses the storage service 109 of the image generation system 106 using the URL, which is received in step S409, for accessing the rendering result stored in the storage service 109, and acquires the stored rendering result.

In step S412, the communication terminal 101 displays the rendering result acquired in step S411 on the display 207. Thus, the screen displaying the website accessed with the URL entered by the user can be viewed.

In step S413, the communication terminal 101 determines whether the information received in step S409 includes error information indicating that the rendering is not generated. If the information is included (YES in step S413), the processing proceeds to step S414. If the information is not included, the processing returns to step S405.

In step S414, the communication terminal 101 displays the error information received in S409 on the display 207.

In step S408, the communication terminal 101 determines whether the operation detected in step S405 is a termination instruction for the cloud browser. If the instruction is to terminate the cloud browser (YES in step S408), the processing proceeds to step S415. If not (NO in step S408), the processing returns to step S405.

In step S415, the communication terminal 101 transmits, to the image generation system 106, a deletion instruction for the root certificate sent in step S404.

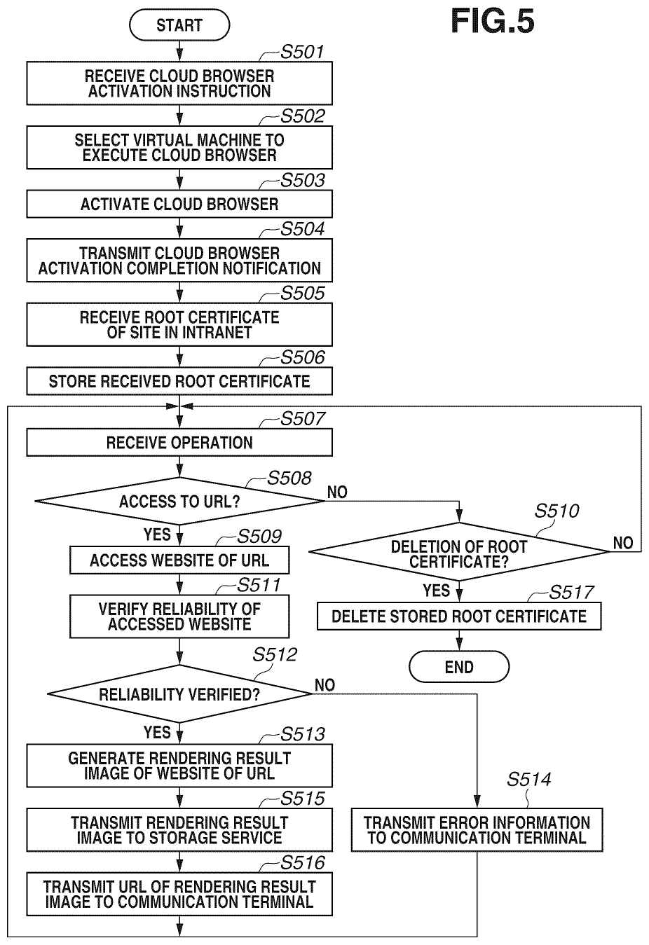

A procedure of the general process of the image generation system 106 on the cloud server according to the present exemplary embodiment will be described with reference to the flowchart illustrated in FIG. 5. The process of the flowchart in FIG. 5, which illustrates the processing of the virtual machine 105 and the browser engine 108, is performed when the CPU 304 stores programs, which are stored in the ROM 305, in the RAM 306, and executes the programs.

In step S501, the gateway 110 of the image generation system 106 receives an activation instruction for a cloud browser from the communication terminal 101.

In step S502, upon receiving the notification of the activation instruction for the cloud browser from the communication terminal 101 in step S501, the gateway 110 selects an available virtual machine using a function of the gateway 110, such as a load balancer. Thus, in the image generation system 106, a plurality of virtual machines can be used, and a virtual machine not being used at the timing of receiving the notification can be selected. The present exemplary embodiment will be described based on the assumption that the virtual machine 105 is selected.

In step S503, based on the activation instruction for the cloud browser, the communication terminal cooperation module 107 of the virtual machine 105 selected in step S502 executes a cloud browser activation processing. Step S503 and the subsequent steps describe the processing of the virtual machine 105.

In step S504, the communication terminal cooperation module 107 transmits, to the communication terminal 101 a completion notification of the activation indicating that the cloud browser is activated.

In step S505, the communication terminal cooperation module 107 receives the root certificate(s) of a site on the intranet from the communication terminal 101.

In step S506, the communication terminal cooperation module 107 stores the root certificate(s) received in step S505 in a shared area of the virtual machine 105. The shared area can be used by the communication terminal cooperation module 107 and the browser engine 108.

In the step S507, the communication terminal cooperation module 107 receives an operation from the communication terminal 101.

In step S508, the communication terminal cooperation module 107 determines whether the operation received in step S507 is an operation for accessing a URL. If the operation is an operation of accessing a URL (YES in step S508), the processing proceeds to step S509. If not (NO in step S508), the processing proceeds to step S510.

In step S509, the terminal cooperation module 107 provides the URL to the browser engine 108 and the browser engine 108 accesses the URL received in step S507 via the gateway 110. In the present exemplary embodiment, suppose that the URL received in step S507 is a URL for accessing the website A 103. The website A 103 is made accessible within the intranet, and its security is enhanced by encrypted communication based on HTTPS connection with the issued dedicated server certificate and root certificate. Thus, by accessing the website A 103, the browser engine 108 can acquire the server certificate for the website A 103.

In step S511, the browser engine 108 verifies the reliability of the website A 103 accessed in step S509. The browser engine 108 performs the verification with the server certificate for the website A 103 acquired in step S509 and the root certificate corresponding to the website A 103 from among the root certificates stored in step S506.

In step S512, the browser engine 108 determines the result of the verification in step S511. If the reliability of the website A 103 is verified as a result of the verification (YES in step S512), the processing proceeds to step S513. If the reliability is not verified (NO in step S512), for example due to an error that occurs in the verification of the reliability, the processing proceeds to step S514.

In step S513, the browser engine 108 generates a rendering result image of the website A 103, and when the rendering is completed, the browser engine 108 notifies the communication terminal cooperation module 107 of the completion of the rendering.

In step S515, the communication terminal cooperation module 107 transmits the rendering result image to the storage service 109.

In step S516, the communication terminal cooperation module 107 transmits, to the communication terminal 101, a URL for accessing the rendering result image transmitted to the storage service 109 in step S515.

In step S514, the communication terminal cooperation module 107 transmits verification error information to the communication terminal 101.

In step S510, the communication terminal cooperation module 107 determines whether the operation received in step S507 is an operation of instructing a deletion of the root certificate. If the operation is the deletion instruction (YES in step S510), the processing proceeds to step S517. If the operation is not the deletion instruction (NO in step S510), the processing returns to step S507.

In step S517, the communication terminal cooperation module 107 deletes the root certificate stored in step S506.

As described above, the process of the communication terminal 101 in FIG. 4 and the process of the image generation system 106 in FIG. 5 enable the cloud browser of the image generation system 106 to verify the reliability of the website A 103 on the intranet 102 and then access the website A 103.

In the present exemplary embodiment, an example is described where the communication terminal 101 transmits a dedicated root certificate with an activation instruction for a cloud browser as its start. The communication terminal 101 can transmit a dedicated root certificate to the image generation system 106 in advance, and the image generation system 106 can set the dedicated root certificate in a specified virtual machine when the cloud browser is activated.

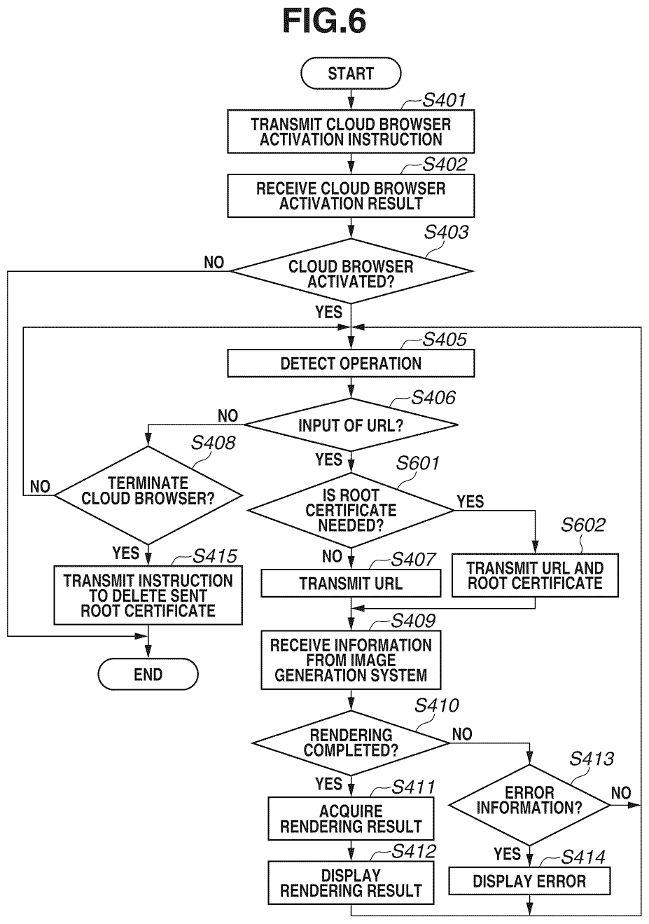

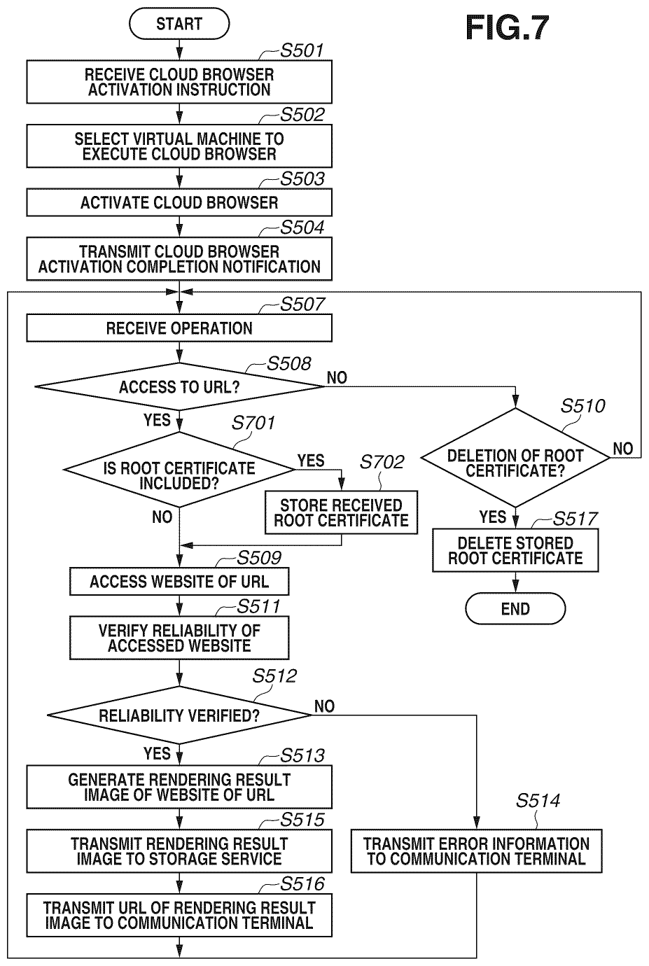

A second exemplary embodiment will now be described. The present exemplary embodiment will be described with reference to FIGS. 6 and 7. In the present exemplary embodiment, a process will be described for a case where the communication terminal 101 determines whether a URL entered by a user thereon is a URL for accessing a website on the intranet, and the URL is used for accessing the website on the intranet according to the first exemplary embodiment. In the present exemplary embodiment, the description of the same processing as that of the first exemplary embodiment will be omitted.

FIG. 6 is a flowchart that includes some parts of the flowchart in FIG. 4, and the description of the same steps will be omitted. The flowchart in FIG. 6 illustrates a procedure after the YES determination is made in step S406 in the flowchart in FIG. 4. In the present exemplary embodiment, step S404 in the flowchart in the first exemplary embodiment is not included.

In step S601, the communication terminal 101 determines whether the URL entered by the user is used for accessing a website on the intranet. In other words, whether a dedicated root certificate is to be used.

If the dedicated root certification is to be used (YES in step S601), the processing proceeds to step S602. If no dedicated root certificate is to be used (NO in step S601), the processing proceeds to step S407. It can be determined whether a dedicated root certificate is to be used by an analysis of the character string of the URL or a comparison between the URL and information about the websites on the intranet held in advance. The determination method is not limited to any particular method.

In step S602, the communication terminal 101 transmits the URL entered by the user and the dedicated root certificate to the image generation system 106.

FIG. 7 is a flowchart that includes some parts of the flowchart in FIG. 5, and the description of the same steps will be omitted. The flowchart in FIG. 7 illustrates a procedure after the YES determination is made in step S508 in the flowchart in FIG. 5. In the present exemplary embodiment, steps S505 and S506 in the flowchart in the first exemplary embodiment are not included.

In step S701, the communication terminal cooperation module 107 determines whether the operation information received in step S507 includes a dedicated root certificate. If the dedicated root certificate is included (YES in step S701), the processing proceeds to step S702. If the dedicated root certificate is not included (NO in step S701), the processing proceeds to step S509.

In step S702, the communication terminal cooperation module 107 stores the received dedicated root certificate in a shared area of the virtual machine 105. The shared area can be used by the communication terminal cooperation module 107 and the browser engine 108.

Consequently, only when a URL with a dedicated root certificate to be used is entered, the communication terminal 101 can transmit the dedicated root certificate to the image generation system 106. As the issue addressed by the first exemplary embodiment, when all of the dedicated root certificates held by the communication terminal 101 are transmitted with the cloud browser activated, more time is taken to transmit the root certificates as the number of root certificates increases. This slows the activation of the cloud browser. The present exemplary embodiment can prevent the activation of the cloud browser from being slowed.

When a URL entered by the user is the URL of a website on the intranet and a dedicated root certificate is used to access the website, the communication terminal 101 can check whether the dedicated root certificate is already stored in the image generation system 106. As the result of the checking, if the dedicated root certificate is not stored, the communication terminal 101 can transmit the dedicated root certificate.

The image generation system 106 can transmit, to the communication terminal 101, information indicating that the verification of the reliability is unsuccessful and information about the target URL as error information. The communication terminal 101 can check whether the dedicated root certificate corresponding to the URL is present, and transmit the dedicated root certificate if present. The above process can accommodate a case where, for example, information about a link to another website is included in the content of the website and a dedicated root certificate is to be used when the user touches the link information and accesses the website.

According to the above-described exemplary embodiments, the reliability of a site within an intranet can be verified by a cloud browser on a virtual machine external to the intranet.

Embodiment(s) of the present disclosure can also be realized by a computer of a system or apparatus that reads out and executes computer executable instructions (e.g., one or more programs) recorded on a storage medium (which may also be referred to as a non-transitory computer-readable storage medium) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-054572, filed Mar. 28, 2024, which is hereby incorporated by reference herein in its entirety.

What is claimed is:

1. An information processing apparatus that provides a rendering result of a web page based on a request from a communication terminal connected to an intranet, the information processing apparatus comprising:
an interface device configured to receive a root certificate for a website on the intranet from the communication terminal; and
a memory storing a program and a processor configured to, when executing the program, cause the information processing apparatus to perform, when the web page of the website on the intranet is rendered, verification of reliability of the website on the intranet with the root certificate.

2. The information processing apparatus according to claim 1, the interface device further configured to transmit, with an error occurrence in the verification of the reliability of the web site when the web page of the website on the intranet is rendered, information about the error and a Uniform Resource Locator (URL) of the website with the error occurrence to the communication terminal.

3. The information processing apparatus according to claim 1, the processor is further configured to cause the information processing apparatus to delete the root certificate.

4. The information processing apparatus according to claim 2, the processor is further configured to cause the information processing apparatus to notify, in a case where the interface device receives a notification of checking whether the root certificate for the website on the intranet is present or absent from the communication terminal, the communication terminal of the presence or absence of the root certificate.

5. A communication terminal that requests an information processing apparatus for a rendering result of a web page, the communication terminal comprising:
an interface device configured to connect to an intranet; and
a memory storing a program and a processor configured to, when executing the program, cause the communication terminal:
acquire a Uniform Resource Locator (URL) for accessing the web page, and
analyze, in a case where the URL is acquired, whether the URL is a URL of a website on an intranet and whether a dedicated root certificate is to be used for accessing the website,
wherein the interface device is further configured to transmit the dedicated root certificate to the information processing apparatus in a case where the dedicated root certificate is used as a result of the analysis.

6. The communication terminal according to claim 5, the processor is further configured to cause the communication terminal to check the information processing apparatus for whether the dedicated root certificate is present or absent in a case where the dedicated root certificate is used as a result of the analysis.

7. An information processing system comprising:
a communication terminal connected to an intranet; and
an information processing apparatus configured to provide a rendering result of a web page based on a request from the communication terminal,
wherein the communication terminal includes:
a memory storing a program and a processor configured to, when executing the program, cause the communication terminal to analyze, in a case where a Uniform Resource Location (URL) for accessing the web page is entered, whether the URL is the URL of a website on the intranet and whether a dedicated root certificate is to be used for accessing the website, and
an interface device configured to transmit the dedicated root certificate to the information processing apparatus in a case where the dedicated root certificate is used as a result of the analysis,
wherein the information processing apparatus includes:
an interface device configured to receive a root certificate for the website on the intranet from the communication terminal, and
a memory storing a program and a processor configured to, when executing the program, cause the information processing apparatus to perform, when the web page on the web site on the intranet is rendered, verification of reliability of the website on the intranet with the root certificate, and
wherein the information processing apparatus accesses the website on the intranet in which the communication terminal is located and provides the communication terminal with a rendering result of the web page on the website on the intranet.
